(19) United States
(12) Patent Application Publication
(10) Pub. No.: US 2017/0262837 A1
(43) Pub. Date: Sep. 14, 2017

(54) MOBILE TRANSACTION DEVICE IMPLEMENTING TRANSACTIONS VIA TEXT MESSAGING

(71) Applicant: PAYPAL, INC., San Jose, CA (US)

(72) Inventor: Jigar Rajnikant Gosalia, Fremont, CA (US)

(21) Appl. No.: 15/195,831

(22) Filed: Jun. 28, 2016

Related U.S. Application Data
(60) Provisional application No. 62/306,018, filed on Mar. 9, 2016.

(51) Int. Cl. G06Q 20/32; G06Q 20/38; H04W 12/06; H04W 4/14; H04L 29/06

(52) U.S. Cl. CPC G06Q 20/3255; H04W 4/14; H04L 63/0428; H04L 63/0492; H04L 63/123; H04W 12/06; G06Q 20/3829; H04L 2209/56; H04L 2209/80; G06Q 2220/00

(57) ABSTRACT

Users may utilize their mobile devices, such as their smart phones, to conduct electronic transactions via text messages. In particular, a mobile app from a transaction service provider may be downloaded and installed at a user's mobile device. The mobile app may allow the user to send transaction requests to the transaction service provider via text messages. A secure RSA token generator may be used to generate a secure token. The text message may include the secure token and may be encrypted. The text message may be communicated to a transaction service provider. The transaction service provider may validate and decrypt the text message. The transaction service provider further may determine the transaction request included in the text message to process the transaction request. The user may log in at the transaction service provider to register the token generator and the user's mobile number with the transaction service provider.

### CROSS REFERENCE TO RELATED APPLICATION

Pursuant to 35 U.S.C. §119(e), this application claims priority to the filing date of U.S. Provisional Patent Application Ser. No. 62/306,018, filed Mar. 9, 2016, which is incorporated by reference in its entirety.

### BACKGROUND

Field of the Invention

The present invention generally relates to a mobile device that is configured to conduct transactions via text messages, and in particular, systems and methods for implementing mobile transactions via text messages.

Related Art

With the popularity of mobile devices, such as smart phones, customers are utilizing their smart phones to perform various functions besides making phone calls. For example, customers may utilize their mobile devices to make electronic payments at various merchants. However, mobile electronic payments may require data service/connection at the mobile devices. When the mobile devices have weak or no mobile data service reception, the mobile devices may no longer able to conduct electronic payments. This may cause inconvenience to the user and may discourage the user from using the mobile device to make payments. Thus, there is a need for a better apparatus or system for conducting electronic payments when the mobile devices are experiencing limited or no data service.

### BRIEF DESCRIPTION OF THE FIGURES

FIG. 1 is a block diagram of a networked system suitable for implementing electronic transactions via text messaging according to an embodiment.

FIG. 2 is a flowchart showing a process for implementing electronic transactions text messaging according to one embodiment.

FIG. 3 is a sequence diagram showing a process for conducting electronic transactions via text messaging in accordance with one embodiment.

FIG. 4 is a block diagram of a computer system suitable for implementing one or more components in FIG. 1 according to one embodiment.

FIG. 5 is a diagram depicting a user interface for user registration according to one embodiment.

FIGS. 6A and 6B are diagrams depicting mobile user interface for conducting electronic transactions via text messaging according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Users may utilize their mobile device, such as their smart phones, to conduct electronic transactions via text messages. In particular, a mobile app from a transaction service provider may be downloaded and installed at a user's mobile device. The mobile app (e.g., TextPal) may allow the user to send transaction requests to the transaction service provider via text messages. A secure RSA token generator app may be used to generate a secure N digit token. The user may log in at the transaction service provider to register the RSA token generator with the transaction service provider. The mobile number of the mobile device also may be registered with the user's account at the transaction service provider.

To conduct electronic connections, the user may enter standard keywords or commands along with the token, such as “send $10.00 to abc@xyz.com #TOKEN”, “request $5.00 from ###-###-#### #TOKEN”, “check balance #TOKEN,” and send the text message or SMS to the transaction service provider. The transaction service provider may designate or set up one or more telephone numbers for receiving transaction requests via text messaging. The transaction service provider may process the text or SMS messages, validate authenticity of the mobile number, RSA token, and the transaction request/command and may respond and process the transaction accordingly. Thus, mobile users may be able to conduct electronic transactions using their mobile devices via text messaging, even when the mobile devices have limited or no internet/data connection.

In an embodiment, a RSA securID authentication mechanism may be used to generate a token at fixed intervals (e.g., every 30 or 60 seconds) using a built-in clock at the mobile device and a factory-encoded random key (e.g., seed) as provided by the transaction service provider. In an embodiment, the seed may be derived from the user's information, such as one or more of the user's email address, phone number, password/pin, secret key (phrase), IMEI number, and current time. Thus, the time-sensitive token may be generated and refreshed from the see, such as the user's information. In an example, the token may be a six-digit number uniquely generated using the user's email address when the user registers at the transaction service provider.

In an embodiment, the text message communication may be encrypted to provide additional security. Various encryption techniques, such as asymmetric encryption (public/private key), time based token, and hash-based message authentication code (HMAC), and the like may be used encrypt the text message communication between the user's mobile device and the transaction service provider. Thus, security may be enhanced for the transaction process.

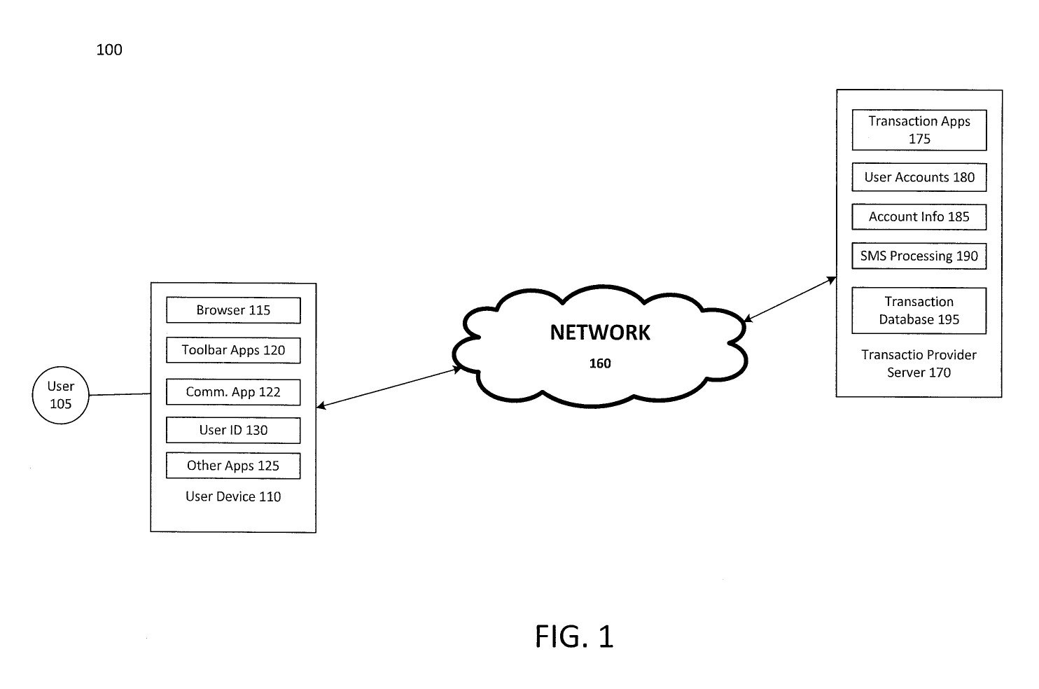

FIG. 1 is a block diagram of a networked system 100 suitable for implementing electronic transactions via text messaging according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT®OS, a UNIX®OS, a LINUX®OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110 and a transaction provider server 170 in communication over a network 160. Transaction provider server 170 may be maintained by a transaction service provider, such as PayPal, Inc. of San Jose, Calif.. A user 105, such as a sender or consumer, utilizes user device 110 to perform a transaction using transaction provider server 170. User 105 may utilize user device 110 to initiate a payment transaction, receive a transaction approval request, or reply to the request via text messaging. Note that transaction, as used herein, refers to any suitable action performed using the user device, including payments, transfer of information, display of information, etc. For example, user 105 may utilize user device 110 to initiate a deposit into a savings account.

In some embodiments, transaction provider server 170 may provide a mobile app that may be installed on user device 110 to facilitate electronic transactions via text messaging. The mobile app may allow the user 105 to generate and send text messages for conducting transactions to the transaction service provider. The text messages may include encoded information and may be associated with the user 105's payment account at the transaction service provider. The text messages may include transaction requests/instructions, security token, and other account/user information. The text message may be encrypted for additional security. The text messages may be communicated through a telephone network (mobile telephone networks). The transaction provider server 170 may receive, validate, and process the text messages from the user device 110. After the text messages are validated, the transaction provider server 170 may process the transactions as requested in the text messages.

User device 110 and transaction provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. In various embodiments, network 160 may include various types of telephone networks, landline networks, wireless networks, cellular networks, and/or other appropriate types of networks, such as Global System for Mobiles (GSM), Code Division Multiple Access (CDMA), Time Division Multiple Access (TDMA), Long-Term Evolution (LTE or 4G LTE), and the like.

User device 110 may be implemented using any appropriate hardware and software configured for wired and/or wireless communication over network 160. For example, in one embodiment, user device 110 may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and text messages through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a transaction service provider to associate user 105 with a particular account maintained by the payment provider. A communications application 122, with associated interfaces, enables user device 110 to communicate within system 100.

User device 110 may include location detection devices, such as Global Positioning System (GPS) devices, configured to detect a location of the user device 110. User device 110 may include a Bluetooth device configured to implement low energy Bluetooth (BLE) communication. For example, user device 110 may detect various low energy Bluetooth signals from Bluetooth beacons installed in a merchant's store. Thus, locations and movements of user device 110 may be determined by positioning techniques, such as triangulation or location fingerprinting. User device 110 also may include various sensors, such as gyroscope, accelerometer, and the like, that are configured to detect a movement and motion experienced by the user device 110.

User device 110 may download and install a mobile transaction app from the transaction provider server 170. The mobile transaction app may provide functions for the user device 110 to receive user instructions for conducting transactions, generate text messages based on the user instructions, and communicate the text messages to the transaction service provider to conduct transactions. The mobile transaction app also may receive text message responses from the transaction provider server.

Transaction provider server 170 may be maintained, for example, by an online transaction service provider which may provide electronic transaction services to user 105.

In this regard, transaction provider server 170 includes one or more transaction applications 175 which may be configured to interact with user device 110 over network 160 to facilitate electronic transactions, communicate/display information, and process transactions as requested by user 105 at user device 110. The transaction provider server 170 may be operated by any financial institution, such as a payment service provider, a bank, a credit union, an investment firm, and the like.

Transaction provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. A unique/secret key also may be generated and associated with the user account. The unique/secret key may be used for generating tokens or for encryption when communicating with the user device 110.

A text message (SMS) processing application 190, which may be part of transaction application 175 or separate, may be configured to receive text messages from user device 110 for processing and validation. SMS processing application 190 may include one or more applications to process information from user 105 for processing transaction requests using various selected funding instruments, including for various banking, payment, funding, fund transfer transactions, and the like. As such, SMS processing application 190 may store details of transaction requests received from individual users, including funding source used, credit options available, etc. Transaction application 175 may be further configured to determine the existence of and to manage accounts for user 105, as well as create new accounts if necessary.

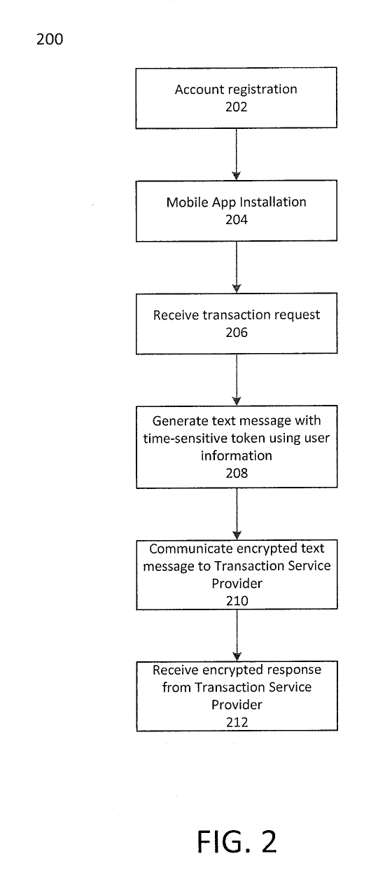

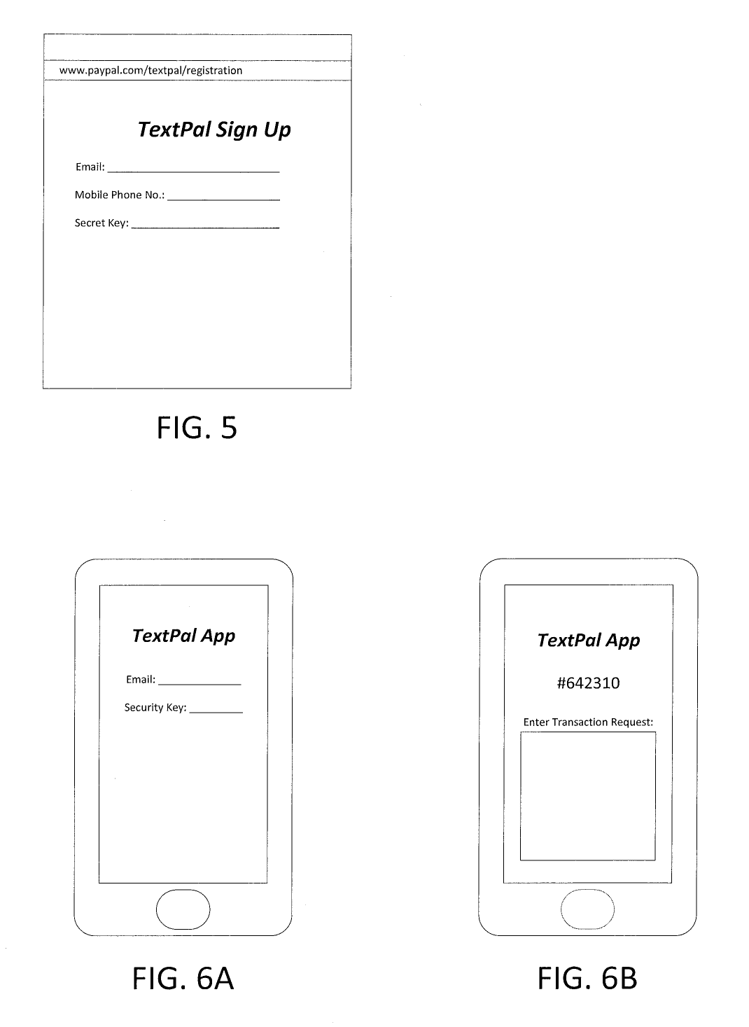

FIG. 2 is a flowchart showing a set up process 200 for facilitating electronic transactions via text messaging according to one embodiment. At step 202, transaction provider server 170 may register user 105 by setting up a transaction/payment account at transaction service provider. User 105 may provide transaction service provider with various personal and financial information, such as name, contact information, funding sources, and the like. As shown in FIG. 5, the transaction provider server 170 may allow the user 105 to sign up or set up for facilitating transactions using text messaging (TextPal). For example, the user 105 may log into the user's online account. The transaction provider server 170 may provide a web page for the user 105 to enter an email address, a mobile phone number associated with the user device 110, a secret key (a pin number or password), or other sign up information. Thus, the transaction provider server 170 may associate the user device 110 with the user 105's account for conducting transactions using text messaging from the user device 110.

In some embodiments, the transaction provider server 170 may retrieve the International Mobile Station Equipment Identity (IMEI) number associated with the user device 110. In particular, the IMEI number may be retrieved from the communication service provider of the user device 110, such as a telecommunication service or network company. The IMEI number of the user device 110 may be associated with the user 105's online account.

At step 204, user 105 may use user device 110 to download and install a mobile transaction application from the transaction provider server 170. The mobile transaction application may allow user to implement and manage various transactions via text messaging using the user device 110. In some embodiments, the mobile transaction application may include a RSA token generator. The RSA toke generator may be configured to generate an authentication token at a particular time interval (e.g., 60 seconds) using a built-in clock and a random key (the seed) issued from the transaction provider server 170. The RSA token generator may allow for two-factor authentication. The RSA token may be a six digit number or any other number of alpha-numeric characters. In an embodiment, the RSA token may be generated from a personal email address of the user 105 registered at the transaction service provider.

At step 206, the user device 110 may receive a transaction request from the user 105. In an embodiment, the user 105 may activate or open the mobile transaction app on the user device 110. The user 105 may be required to log in to the user account. For example, as shown in FIG. 6A, the mobile transaction app may provide a mobile user interface on the user device 110 for the user 105 to enter the user's user ID (email address) and password (security key or pin number). If the user 105 enters the correct user ID and password, the user 105 may be authenticated to use the mobile transaction app.

In some embodiments, when the user 105 enters the correct user ID and password, the mobile transaction app on the user device 110 may access the phone number and the IMEI number of the user device 110. The user ID, password, phone number, and IMEI associated with the user device 110 may be communicated to the transaction provider server 170. The transaction provider server 170 may match the received user ID, password, phone number, and IMEI with those stored with the user's profile at the transaction provider server 170 to authenticate the user 105 and the user device 110.

As shown in FIG. 6B, after the user 105 is properly authenticated, the mobile transaction app may provide a mobile user interface on the user device 110 that allow the user 105 to enter the transaction request as text messages. As shown in FIG. 6B, the mobile transaction app may automatically generate an RSA token (e.g., #642310). As noted above, the RSA token may be generated based on an internal clock and a seed originated from the transaction service provider. In an embodiment, the seed may be derived from the user's information, as previously registered at the transaction service provider, such as the user's email address, the user's mobile phone number, the IMEI number of the user's mobile phone, the user's password/pin number, and/or the current time. The token may have expiration (e.g., one minute). The token may automatically be refreshed periodically (e.g., every minute). In an embodiment, the token may be refreshed at a particular frequency, based on the location of the user device 110. For example, the user device 110 may detect, based on GPS or other location, that the user device is at a familiar location (user's work or user's home), the token may be refreshed less frequently as compared to when the user device is at a new location (unfamiliar location).

As shown in FIG. 6B, the token may be displayed in the mobile user interface of the mobile transaction app. A user input area may be provided below the token for the user to enter transaction requests. The user may type in (or by voice dictation) command lines as transaction requests. A transaction command may include an action word and subject matter.

For example, the user 105 may enter transaction commands, such as “check balance,” “transfer $100 to XXX,” “pay XXX $50,” “request $20 from XXX,” “lend $30 to XXX,” “borrow $15 from XXX,” “send $25 to ###-####” and the like. Multiple commands may be entered together, such as: “Pay X $50 and Pay Y $30.” A series of commands may be entered together, such as “Request $50 from X to pay Y $50.” A command may include multiple subjects, such as “Pay each of A, B, and C $10.” In an embodiment, the mobile transaction app may provide examples of command lines, such that the use 105 may learn how to enter proper command lines.

After the user 105 finalizes and enters the command line, the mobile transaction app may generate a text message based on the command line at step 208. The mobile transaction app may automatically add or append the token to the end or the beginning of the command line, such as “transfer $100 from account A to account B; #642310.” In some embodiments, the token may be an image, such as an image of a bar code or QR code. In an embodiment, the mobile transaction app may encrypt the text message including the command line to enhance security. Various encryption techniques, such as asymmetric encryption (public/private key), may be utilized to encrypt the text message. The text message may include additional information, such as the identity of the sender, the mobile number of the sender, time, date, location where the text message originates, the destination/receiver's number, and the like.

In some embodiments, the text messages communicated between the user device 110 and the transaction provider server 170 may be encrypted by the user device 110 and the transaction provider server 170 respectively. The encryption may use multiple public keys, such as one or more of the user 105's email address, user ID, phone number, IMEI number, and the like, and a private key, such as the password/pin number/pass phrase previously selected by the user 105. Thus, the communication between the user device 110 and the transaction provider server 170 may encrypted for additional security. For example, salt cryptography may be used to provide hash functions for encryption.

At step 210, the user device 110 may communicate the text message including the transaction request to the transaction service provider (e.g., transaction provider server 170). The text message may be transmitted via the network 160, such as a telephone network and/or cellular network. For example, the text message may be communicated to a network of a telephone communication provider. The telephone network may include one or more short message centers that may store and forward text messages to and from mobile stations. The short message center may then forward the text messages to the transaction service provider.

The transaction service provider may designate one or more mobile numbers for receiving text messages with transaction requests from the customers. For example, the mobile transaction app may select a mobile number of the transaction service provider and may send the text message to the selected mobile number of the transaction service provider. The mobile transaction app may select the mobile number based on the location of the user device 110. For example, the transaction service provider may designate different mobile numbers for different geographical locations/regions. The mobile transaction app may select the mobile number that matches or is closest to the locations/regions as designated by the transaction service provider. This may save on text/communication fees for the users. In an embodiment, the mobile transaction app may select the mobile number based on availability and/or communication traffic. For example, the transaction provider server 170 may indicate that a mobile number is experiencing heavy incoming text messages/traffic, the mobile transaction app may select a different mobile number to avoid congestion.

The transaction service provider may designate different mobile numbers for different types of transactions. For example, the transaction service provider may designate one mobile number for receiving requests for account information, one mobile number for receiving requests for fund transfers, one mobile number for receiving requests for funding, one mobile number for receiving requests for purchase payments, and the like. Thus, the mobile transaction app may send text messages to different telephone numbers based on different types of transactions being requested by the user 105.

In an embodiment, the transaction provider server may designate different mobile numbers for different types of users. For example, the transaction service provider may designate one mobile number for merchants, one mobile number for consumers, one mobile number for VIP users, and the like. Thus, the mobile transaction app at the user device 110 may select a number of the transaction service provider to send the text message based on various factors.

The transaction provider server 170 may receive the text message including the transactions requests sent from the user device 110. The transaction provider server 170 may authenticate and validate the text message to make sure that the text message is legitimate and correct. In particular, the transaction provider server 170 may first identify the mobile number from which the text message originates. The transaction provider server 170 check to see if any of the accounts on file with the transaction service provider associate with the mobile number from which the text message was sent. If no accounts were found to associate with the mobile number, the transaction provider server 170 may generate an error message and send the error message back to the user device 110, at step 212.

If an account is found to associate with the mobile number from which the text message was sent, the transaction provider server 170 identity the token in the text message and may perform RSA token validation to validate the token with the account. For example, the transaction provider server 170 may determine whether the token received matches the one generated at the transaction provider server 170 based on the current time and the previously designated seed value/algorithm. If the token is not validated, the transaction provider server 170 may generate an error message and send the error message back to the user device 110, at step 212.

If the token is validated, the transaction provider server 170 may perform additional security checks. For example, if the text message is encrypted, the transaction provider server 170 may decrypt the text message based on previously agreed upon encryption techniques (e.g., using private/public key). If text message is not able to be decrypted, the transaction provider server 170 may generate an error message and send the error message back to the user device 110, at step 212.

For example, the text message may be decrypted using multiple public keys, such as one or more of the user ID, email address, phone number, and IMEI number of the user device 110, and the private key, such as the secret key, password, or passphrase previously selected by the user 105. Further, the transaction provider server 170 also my check the token included with the text message against the token previously generated by the transaction provider server 170 for the user 105. By using the phone number and IMEI for encryption, the system may ensure that only the user with the same phone number (e.g., SIM card) and the same user device 110 may view the text message.

The transaction provider server 170 also may check the time, date, and, location at which the text message was originated/sent to see if they conform with the user 105's normal behavior. For example, if the text message is sent from a new location where the user 105 has never been, the transaction provider server 170 may implement additional security measures, such as delaying the transaction request or request additional user authentication before processing a request.

If the token is validated, the transaction provider server 170 may begin to analyze the text message to determine the transaction request/command. The transaction provider server 170 may search for transaction related action words in the text message, such as “check,” “request,” “deposit,” “pay,” “transfer,” “borrow,” “lend,” “cancel,” “move,” “withdraw,” and the like. The transaction provider server also may search for subjects and objects in the text message. The subject or objects may be an account, a person's name, a phone number, a user name, a merchant, a financial institution, a group, an organization, and the like. For example, the text message may state: “pay XX $20,” or “request $10 from YY.” The text message also may identify the amount of transaction, typically a number with a dollar sign, such as $20, or in spelled out words, such as “twenty dollars.” Thus, the payment provider may analyze the text message to determine the transaction being requested by the user.

In an embodiment, the transaction provider server 170 access the user 105's transaction history, which may be used to quickly determine the current transaction requests. For example, based on the user 105's transaction history, the transaction provider server 170 may quickly identify a same or similar transaction request previously processed, the transaction provider server 170 may quickly determine that the same transaction request is currently being requested, without having to go through extensive analysis.

In an embodiment, the transaction provider server 170 may determine the user 105's current transaction request based on other users' transaction requests or transaction history.

For example, the transaction provider server 170 may learn the various common transaction requests received from the other users. Thus, the transaction provider server 170 may learn and determine the user 105's current transaction based on crowd sourcing from other users' transaction requests. If no transaction request is determined from the text message, the transaction provider server 170 may generate an error message and send the error message back to the user device 110, at step 212.

If a valid transaction request/command is determined from the text message, the transaction provider server 170 may process the transaction based on the request/command, such as making a payment, conducting a fund transfer, and the like. The transaction provider server 179 may generate and send a text messages back to the user device 110 indicating that the transaction request/command has been successfully processed and completed.

In an embodiment, if the user device 110 is lost, stolen, or compromised, the user 105 may use a different device to log in at the transaction provider server 170. The user 105 may request to deactivate the compromised user device 110. The transaction provider server 170 may refresh the user 105's account/profile and may flag the user device 110 as compromised.

In some embodiments, the transaction provider server 170 and may disassociate the IMEI number of the compromised user device 105 from the user 105's account/profile. As such, the compromised user device 105 may no longer be used for transactions via text messages with the user 105's account/profile. In an embodiment, the transaction provider server 170 may provide options for the user 105 to associate the user 105's account/profile with a new device. Thus, the user 105 may set up a new device with the user 105's account/profile for implementing transactions via text message. The set up process for the new device may be similar to those in step 202 of method 200 in which the new device is associated with the user 105's account/profile at the transaction provider server 170. For example, the transaction provider server 170 may use the phone number of the new device to retrieve the IMEI number of the new device from the communication service providers, such as via the communication service providers' API's. The IMEI number of the new device may be associated with and stored with the user 105's account/profile. The mobile transaction app may be downloaded from the service provider server 170 to the new device for implementing transactions via text messages.

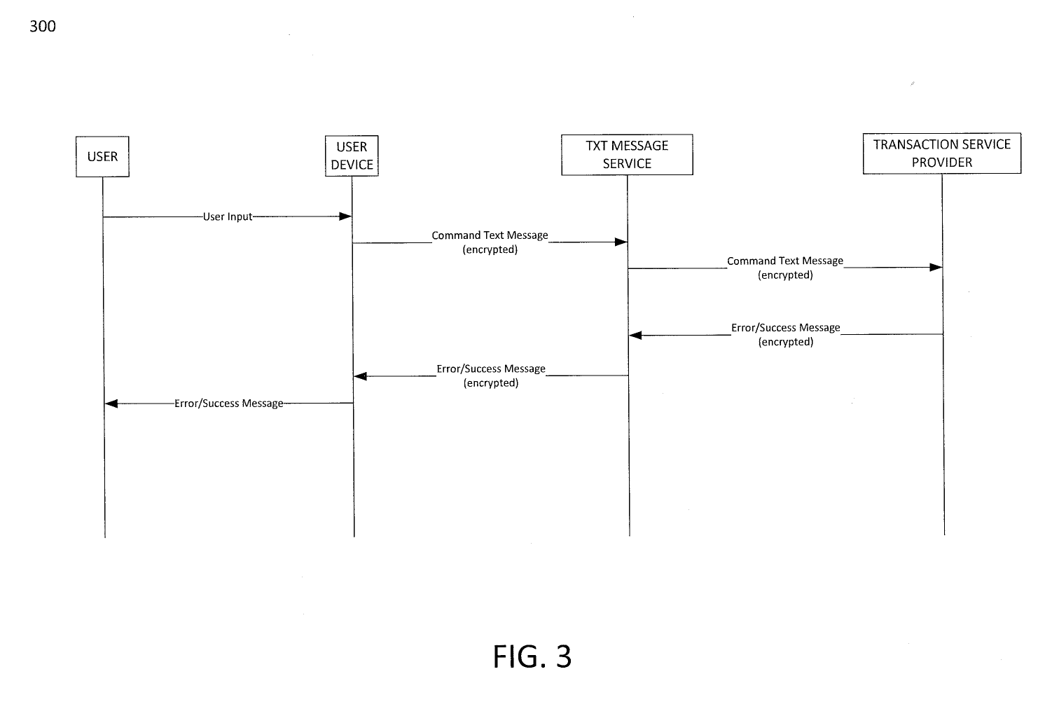

FIG. 3 is a sequence diagram showing a process for conducting electronic transactions via text messaging in accordance with one embodiment. The user may first provide user input at the user device, such as logging into the mobile transaction app at the user device 110 and inputting transaction requests/commands at the user device 110 in step 206. The user device 110 may then generate and communicate the text message to a text messaging service, such as a telephone communication service provider. The text messaging service may relay the text message to the transaction service provider. The transaction service provider may validate and analyze the text message. Based on whether the text message is valid, the transaction service provider may send an error or success message back to the text messaging service, which then relays the text message back to the user 105 at the user device 110.

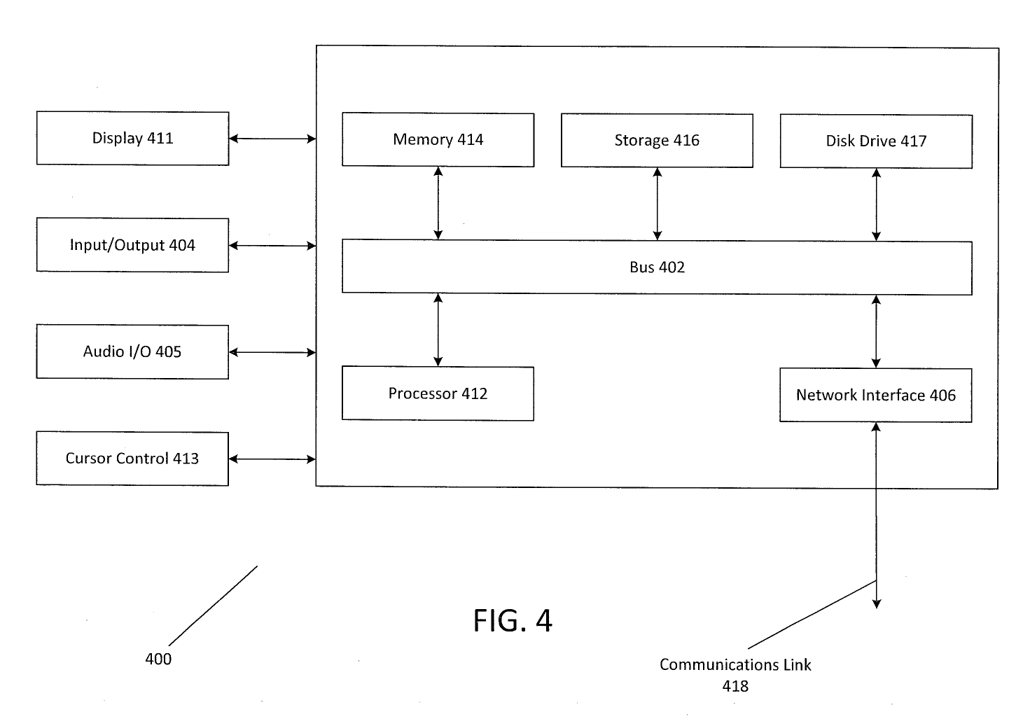

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a transaction provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile transaction apparatus comprising:
a non-transitory memory;
a user input device configured to receive user input;
a text message communication device configured to send or receive text messages via a telephone network;
one or more hardware processors coupled to the non-transitory memory and configured to read instructions from the non-transitory memory to cause the mobile transaction apparatus to perform operations comprising:
receiving, by the user input device, a transaction request from a user;
generating a text message including the transaction request;
encrypting the text message; and
communicating the text message to a transaction service provider to instruct the transaction service provider to process the transaction request.

2. The mobile transaction apparatus of claim 1 further comprising a token generator configured to generate and refresh a token periodically for inclusion with the text message.

3. The mobile transaction apparatus of claim 2, wherein the token is a series of alphanumeric characters and is automatically appended to the text message.

4. The mobile transaction apparatus of claim 2, wherein the token is generated based on one or more of an email address of the user, a phone number of the mobile transaction apparatus, an International Mobile Station Equipment Identity (IMEI) number of the mobile transaction apparatus, a secret key, and a current time.

5. The mobile transaction apparatus of claim 1, wherein the text message is encrypted by public keys and a private key.

6. The mobile transaction apparatus of claim 5, wherein the public keys comprise one or more of an email address of the user, a phone number of the mobile transaction apparatus, and an IMEI number of the mobile transaction apparatus.

7. The mobile transaction apparatus of claim 5, wherein the private key comprises a secret code or phrase previously provided by the user during a sign up process.

8. The mobile transaction apparatus of claim 1, wherein the operations further comprise:
receiving a responding text message from the transaction service provider;
decrypting the responding text message based on one or more of an email address of the user, a phone number of the mobile transaction apparatus, an International Mobile Station Equipment Identity (IMEI) number of the mobile transaction apparatus, and a secret key.

9. The mobile transaction apparatus of claim 1, wherein the text message comprises command words instructing the transaction service provider to process the transaction request.

10. The mobile transaction apparatus of claim 1, wherein the text message is communicated via one or more of a short message service (SMS) and a multimedia message service (MMS).

11. A system comprising:
a non-transitory memory; and
one or more hardware processors coupled to the non-transitory memory and configured to read instructions from the non-transitory memory to cause the system to perform operations comprising:
receiving a text message including a transaction request from a user device via a telephone network;
decrypting the text message;
validating the text message;
determining the transaction request from the text message; and
processing the transaction request.

12. The system of claim 11, wherein the text message is decrypted based on public keys and a private key.

13. The system of claim 12, wherein the public keys comprise one or more of an email address of a user of the user device, a phone number of the user device, and an International Mobile Station Equipment Identity (IMEI) number of the user device.

14. The system of claim 12, wherein the private key comprises a secret code or phrase previously provided by a user of the user device during a sign up process.

15. The system of claim 11, wherein the operations further comprise:
validating a token included with the text message received from the user device; and
processing the transaction request when the token is validated.

16. The system of claim 15, wherein the token is a series of alphanumeric characters and is generated based on one or more of an email address of a user of the user device, a phone number of the user device, an IMEI number of the user device, a secret key, and a current time.

17. The system of claim 11, wherein the operations further comprise:
generating a responding text message in response to the transaction request;
encrypting the responding text message based on one or more of an email address of a user of the user device, a phone number of the user device, an IMEI number of the user device, and a secret key previously provided by the user during a sign up process.

18. The system of claim 17, wherein the responding message comprises an error message indicating that the text message is not validated.

19. A non-transitory machine-readable medium having stored thereon machine-readable instructions executable to cause a machine to perform operations comprising:
receiving a text message including a transaction request from a user device via a telephone network;
decrypting the text message;
validating the text message;
determining the transaction request from the text message; and
processing the transaction request.

20. The non-transitory machine-readable medium of claim 19, wherein the text message is decrypted based on one or more of an email address of a user of the user device, a phone number of the user device, an International Mobile Station Equipment Identity (IMEI) number of the user device, and a secret code or phrase previously provided by the user during a sign up process.
